(19) United States
(12) Patent Application Publication
(10) Pub. No.: US 2008/0285818 A1
(43) Pub. Date: Nov. 20, 2008

(54) Fingerprint verification system for computerized course attendance and performance testing

(76) Inventor: Hardy Warren, Westlake, CA (US)

Correspondence Address: Robert N. Schlesinger, 7289 Meadowlark Place, Rancho Cucamonga, CA, 91701, US

(21) Appl. No.: 11/804,190

(22) Filed: May 17, 2007

(51) Int. Cl. G06K 9/00

(52) U.S. Cl. 382/124

(57) ABSTRACT

This “Fingerprint Verification System for Computerized Course Attendance and Performance Testing”, relates to a new, useful, and significant means and method of verifying the identity of a computerized or computer-based course enrollee, and verifying said enrollee's attendance throughout the computer-based course, and the enrollee's identity during test taking throughout the course. Such a computer-based course may be online or off-line, but in both sets of embodiments, fingerprint identification of the enrollee is required, and at times, periodic, random, or a combination thereof, specifically designed to reliably verify the identity of the enrollee, and to overcome counter-measures an enrollee may attempt to enter a false positive fingerprint identification.

relates to a new, useful and significant means and method of verifying the identity of a computerized or computer-based course attendee, and said attendee's attendance throughout the computer-based course, and the attendee's identity during test taking throughout the course. Such a computer-based course may be online or off-line, but in both sets of embodiments, fingerprint identification of the attendee is required, and at times specifically designed to reliably verify the identity of the attendee, and to overcome counter-measures an attendee may attempt to enter a false positive fingerprint identification.

This “Fingerprint Verification System for Computerized Course Attendance and Performance Testing” will hereinafter be referred to as the “Fingerprint Verification System”, and as a proper noun with the first letter of each word capitalized, throughout this specification and its appended claims.

The term “course” or “course of study”, as used throughout this specification and its appended claims is intended to be broadly construed, and is intended to also refer to lessons, programs of study, certificate, certification, and degree-granting courses of study, that may be completed online, off-line, or part online and part off-line. The term “course” is also intended to include such specialized programs as may be approved, allowed, or required by a Court or Hearing, such as Traffic School or Workplace Safety Classes, or such recertification or continuing education courses, required or allowed by a licensing agency or the like, for maintaining one's certification or license in the various fields, such as nursing, law, accounting, investment and real estate brokering and the like, that are regulated and require periodic additional coursework or educational updates for one's license to remain current and active.

The term “test” or “testing” as used throughout this specification and its appended claims is intended to be broadly construed, and is intended to also refer to quizzes, examinations, written work, including essay writing, and oral examinations over the internet, on a memory device, or the like.

The term “memory device” as used throughout this specification and its appended claims is intended to be broadly construed, and is intended to also refer to hard drives, floppy disks, compact disks (“CD”), digital video disks (“DVD”), memory sticks and drives such as jump drives and the like, memory cards, memory chips, tape drives and the like, data banks, and the like, and downloads onto a memory device (6) or another computer, such as the school's computer (4) or web server (4).

The term “computer” as used throughout this specification and its appended claims is intended to be broadly construed, and is intended to also refer to networked terminals, desktop computers, laptop computers, handheld computers, portable computers, hybrid television and computer devices, and the like. There are two sets of computers that are generally used in the Fingerprint Verification System. They are the enrollee computer (1) and the school computer (4), which may be a web server or web server farm. Some embodiments of the enrollee computer (1) may be a library computer or an employer's computer, or another computer that is available to community members or those taking the course. Some embodiments of the Fingerprint Verification System do not require the use of a school computer (4), but may utilize a memory device that is installed into the enrollee computer (1) or may utilize code and course content that is downloaded into the enrollee computer (1). Such examples are generally off-line applications of the Fingerprint Verification System. Some embodiments of the Fingerprint Verification System may additionally be in communication with one or more government computers (5), with said communication link being between the enrollee computer (1) or the school computer (4), or both computers (1, 4), and said government computer (5). Some embodiments of the school computer (4) or the government computer (5) may be a data bank for receiving, storing, or processing enrollee or school data.

The term “communication” as used throughout this specification and its appended claims is intended to be broadly construed, and is intended to refer to hard-wired communication, as well as electromagnetic (such as radiofrequency or microwave), optical, or fiber optic communication. The term “communication link” as used throughout this specification and its appended claims is intended to be broadly construed, and is intended to refer to hard-wired or wireless communications connections between a computer, computer hardware, or peripherals, or may refer to the hard-wired, wireless, networked, or internet connected communication links between a plurality of computers, including the enrollee computer (1), or the equivalent such as a library computer, and the school computer (4), or the equivalent such as a data bank, remote website, web server or web server farm. Some communications links (7-9 and 11) referred to in the specification and its appended claims may be both hard-wired and wireless, along the communications link. The communications links (7-9 and 11) shown in the drawing figures are intended to reflect the flow of information in said links. The shown links (7-9 and 11) therefore show a half-arrowhead in each of the two directions, with the primary direction of information flow being shown with the half-arrowhead on the top right part of the link shown, and indicating information generally flowing to the right side of the drawing figure. See: FIGS. 1-9, thereto. If there is a secondary or minor information flow, it is typically in the opposite direction, and shown with a half-arrowhead to the left, and shown on the left side of the link. See: FIGS. 1-9. The communications links (7-9, and 11) shown in the drawing figures, FIGS. 1-9, are not drawn to scale, and may be many miles, or many thousands of miles in length, which is a major advantage of the present invention, allowing education services over great distances.

The term “fingerprint” as used throughout this specification and its appended claims is intended to be broadly construed, and is also intended to refer to a thumbprint, or even a toe print, and may include a partial fingerprint or the like, assuming it passes the security requirements of the Fingerprint Verification System.

The term “fingerprint verification device” (3) as used throughout this specification and its appended claims is intended to be broadly construed, and is intended to refer to both independent fingerprint devices (3) in communication with the enrollee's computer (1), as well as fingerprint verification devices (3) that may be incorporated into the enrollee computer (1) housing or the enrollee's computer monitor, keyboard, mouse, laptop memory card, camera device, or other peripheral devices.

The term “random” as used throughout this specification and its appended claims is intended to be broadly construed, and is intended to also refer to pseudorandom or seemingly random, which are also intended to be broadly construed. A so-called “random” or “pseudorandom” or “seemingly random” sequence of numbers under this definition may not be a normal number, in the strict number theoretic sense, but would be as close as the system designer desires to such number theoretic normality. Said sequence's distribution of digits would not follow Benford's Law, as this would indicate a significant deviation from randomicity or pseudorandomicity. Such randomicity, pseudorandomicity, or seeming randomicity may be generated, for purposes of this Fingerprint Verification System, by using non-random numbers manipulated to appear random or pseudorandom. For example, one might use a sequence of prime numbers or a recurrence of said prime number sequence, that might include one or more twin primes, and such numbers may represent minutes into the course where the fingerprint device (3) is activated to require a fingerprint verification. A random number table, such as the RAND Table of Random Numbers, may also be used in a similar manner. Data logs and the like, of random radioactive emissions are available and may also serve as a random number generator.

### FIELD OF THE INVENTION

As noted above, this Fingerprint Verification for Computerized Course Attendance and Performance Testing relates to a new, useful and significant means and method of verifying the identity of a computerized or computer-based course attendee, and said attendee's attendance throughout the computer-based course, and the attendee's identity during test taking throughout the course. Such a computer-based course may be online or off-line, but in both sets of embodiments, fingerprint identification of the attendee is required, and at times specifically designed to reliably verify the identity of the attendee, and to overcome counter-measures an attendee may attempt to enter a false positive fingerprint identification. In short, one might think of the Fingerprint Verification System as a new, useful, and significant means of assuring a school or the like, and the government if they are an interested party, that the identity of an attendee and examinee for a computerized course is the same as the identity of the course's enrollee, and that the enrollee is in attendance throughout much of the computerized course.

### DESCRIPTION OF THE RELATED ART INCLUDING INFORMATION DISCLOSED UNDER 37 CFR 1.97 AND 1.98

Many industries and aspects of everyday living are changing with the advent of personal computers, laptop computers, and data communications. The present Fingerprint Verification invention was conceived, devised, invented, and engineered to make education and required and elective courses more accessible to those with access to a computer and to those with online access, and to make enrollment, attendance monitoring, and enrollee and examinee identity more reliable and without requiring significant computer hardware or software installation, or significant time delays.

Accessibility to educational courses and programs is difficult for a number of sets of prospective students, and for a variety of reasons. Such accessibility to campus and classroom problems exist for those prospective students with physical handicaps and challenges, those with mental and psychological handicaps and challenges, those that have a disease, syndrome or medical condition making it impractical or undesirable to be in a classroom situation, those of an advanced age, those that are unusually young and have transportation problems, those that reside or work in remote and inaccessible locations, those that are often traveling as is common with entertainers and salespersons, those that are in the military or diplomatic corps, those that are incarcerated, those that have a work schedule requiring day sleeping, those with family responsibilities such as caring for one or more children or persons with special needs, those that are responsible for the care of farm or veterinary animals or the like, those with extremely tight scheduling problems and are unable to commute to a campus, those that due to their fame, wealth, or notoriety can not be on a campus without causing disruption, and those that work or reside in distant lands such as another state, country or continent. A means and method of increasing accessibility to educational courses and programs would clearly be beneficial to many persons that otherwise may not have access to further education opportunities and required courses and programs.

Broader accessibility to educational courses and programs is also beneficial to the commercial and academic institutions offering such courses and programs. Such broader accessibility brings said institutions increased enrollment and additional tuition and fees. Increased enrollment is likely to also increase the institution's grant and endowment funds. Broader accessibility, if not mismanaged, would also increase the stature of the institution, particularly if the institution was so offering courses and programs that are difficult to otherwise find, and taught by well-known authorities. Such increased stature would also be expected to increase the endowment for the institution.

A number of means and methods have been tried to increase accessibility of prospective students to educational institutions and programs. Such means and methods have involved the use of correspondence courses, televised courses, and video-taped courses. Most recently, there have appeared some online courses, available on the internet. A significant problem with each of these means and methods is that of authenticating the identity of the enrollee, validating the attendance of the enrollee, and authenticating the identity of the quiz, test, or exam taker or essay writer. Solutions to the quiz, test, and exam taker's identity problem have included proctoring at a remote location or taking the exam or the like, on the campus of the institution offering the course or program. Other solutions may include the use of a pass word, but this solution does not guarantee the identity of the attendee or examinee. These so-called solutions are impractical and inconvenient, particularly for short courses and one-day courses or programs.

### SUMMARY OF THE INVENTION

The inventor of the Fingerprint Verification System, Hardy Warren, owns and operates a group of traffic schools. Typically, a traffic school course lasts eight hours, and is concluded the same day with a test. Traffic school is typically desired by the enrollee following issuance of a traffic ticket or conviction of a traffic infraction. The enrollee's traffic ticket or infraction being purged from their government traffic record following the successful completion of the traffic school course. This purging of the traffic ticket or infraction may also prevent an increase in the enrollee's insurance rate. Attendance at traffic school, and other educational institutions, is sometimes most difficult or inconvenient for some persons, as noted above. In trying to solve these disadvantages and problems, and in trying to broaden accessibility to educational courses generally and to special programs, the inventor devised and invented a new and useful solution to these problems by devising and inventing a computerized course with fingerprint identification to authenticate the identity of the enrollee, attendee, and examinee, and to assure that they are one and the same person.

The advantages of the Fingerprint Verification System are significant and are cited below. The Fingerprint Verification System allows accessibility to education courses and programs to many persons that would otherwise not have access. The Fingerprint Verification System allows easier accessibility to education courses and programs to many persons that would otherwise not have reasonable access. The Fingerprint Verification System allows for low cost operation. The Fingerprint Verification System may be operated online and over the internet. The online embodiment of the Fingerprint Verification System may be operated in any regions with a data communications link, such as a telephone line, cell phone link, cable, or radio communications, for the enrollee-school communications link (7). Some embodiments of the Fingerprint Verification System may be operated on an enrollee computer (1) off-line with the software and course content on one or more disks or a memory device (6) and installed onto the enrollee computer (1). Some embodiments of the Fingerprint Verification System are compact and portable. The Fingerprint Verification System is relatively easy to use. The Fingerprint Verification System is reliable. The Fingerprint Verification System provides a variety of new, useful; and significant counter-measures and counter-counter measures to various measures that an enrollee or attendee may use to misrepresent course attendance or the true identity of the examinee.

One remaining potential problem with a fingerprint verification system is that the attendee may log-in and may then abandon the course, typically until it is time to log-off. Another remaining potential problem with a fingerprint verification system is that the examinee may log-in and may then allow another person to take said examinee's test or exam. The present Fingerprint Verification System invention allows the school or course sponsor to overcome these potential problems by requiring fingerprint verification a plurality of times during the required attendance of the online or off-line computerized instruction, and during any required tests or exams. The Fingerprint Verification System may require fingerprint verification at a set time or times, periodically, as a function of time or as a function of selected points during the progress of the online or off-line computerized instruction and testing. The Fingerprint Verification System may alternatively require fingerprint verification be taken at random, pseudorandom, or seemingly random times, during the online or off-line computerized instruction and testing. Hybrid embodiments of the Fingerprint Verification Systems may use a combination of periodic and seemingly random times for verifying the enrollee's fingerprint. This sort of requirement that the attendee or examinee be given a prompt, a notice, or the like, either on the computer monitor (2) or through the computer speaker, or both, and then allowing the attendee or examinee a reasonable amount of time, such as between 5 and 15 seconds or more, to enter or scan their fingerprint on the fingerprint verification device (3), would greatly reduce the chances of enrollee fraud or misrepresentation in monitoring online or off-line computerized attendance and testing. Such a period of time is sufficient to allow the enrollee to scan and enter their fingerprint, but is generally insufficient time to get a remote enrollee to return to the computer (1) and perform the required fingerprint verification tasks on the fingerprint verification device (3).

The above disclosed counter-measures and counter-counter-measures are new, useful, significant and essential for any viable and credible online and computerized off-line instruction, courses, and programs. In this day and age, some enrollees are challenged to find measures to by-pass attendance requirements and test-monitoring. This might be particularly true for enrollees in the likes of such programs as are taught at online Traffic School, where the attendees are coerced into enrolling to have a traffic ticket or infraction removed from their driving record, or at on-line required core curriculum courses in mathematics or foreign languages, as well as other courses that are perceived as difficult. Continuing education courses for various professions may also be viewed by many enrollees as a nuisance, and may therefore require one or more such fingerprint verification counter-measures, as are elements of the present invention.

There are a variety of embodiments of this Fingerprint Verification System, and its inventive concept, as disclosed below.

### BRIEF DESCRIPTION OF THE DRAWING FIGURES

The drawing figures reflect selected embodiments of the Fingerprint Verification System, and as intended for use as a stand alone system or as an independent subset of a larger and more advanced or complicated system. The Fingerprint Verification System is not intended to be so limited, however, and is intended that some embodiments may be incorporated into more extensive or elaborate systems.

Referring again to the drawing figures, like reference numerals are used to refer to like or similar specific parts or elements of the Fingerprint Verification System, as shown in the various drawing figures, and throughout this specification and its appended claims.

FIG. 1 shows a plan view of an online Fingerprint Verification System, and showing an enrollee computer (1) connected online to and in communication (7) with a school computer (5) or its website, and showing a fingerprint identification device (3) that is connected to and in communication (9) with said enrollee computer (1). Also shown are the optional government computer (5) and the optional bank computer (10), and their optional communications links (8 and 11, respectively).

FIG. 2 shows a block diagram for an online Fingerprint Verification System with periodic fingerprint authentication times.

FIG. 3 shows a block diagram for an online Fingerprint Verification System with random fingerprint authentication times.

FIG. 4 shows a block diagram for an online Fingerprint Verification System with periodic and random fingerprint authentication times.

FIG. 5 shows a plan view of an off-line Fingerprint Verification System, and showing an enrollee computer (1), with software and course content memory disks (6) shown nearby, and showing a fingerprint identification device (3) connected to and in communication (9) with said enrollee computer (1).

FIG. 6 shows a block diagram for an off-line Fingerprint Verification System with periodic fingerprint authentication times.

FIG. 7 shows a block diagram for an off-line Fingerprint Verification System with random fingerprint authentication times.

FIG. 8 shows a block diagram for an off-line Fingerprint Verification System with periodic and random fingerprint authentication times.

FIG. 9 shows a block diagram for an online Fingerprint Verification System with optional communications links (8 and 11, respectively) between the school computer (4) and a government computer (5) and a bank computer (10).

### DETAILED DESCRIPTION OF THE INVENTION

There are a variety of embodiments of this inventive concept, with these variations generally relating to the fingerprint authentication times or the fingerprint authentication algorithm used. A description of these various embodiments follows below.

### Description of Simple Online Embodiments

A simple embodiment of the online Fingerprint Verification System would be comprised essentially of an enrollee computer (1) connected to the internet, with a telephone line, cable communications, or the like, and having an enrollee-school communications link (7) with a school computer (4), and with data flowing along said link (7) and between both the enrollee computer (1) and the school computer (4). A fingerprint verification device (3) is connected to and in communications with the enrollee computer (1) with a fingerprint device communications link (9), and said device (3) is indirectly in communication with the school computer (4), by way of the enrollee computer (1) and with the enrollee-school communications link (7). The level of security for the fingerprint verification device (3) is typically factory set, and is set so that the enrollee is reliably identified when the fingerprint verification device (3) is activated and used. A higher level of security may be achieved by adjusting the resolution or the number of matching fingerprint identifiers, such as fingerprint loops, curves, and the like, required on the fingerprint verification device (3), to recognize a fingerprint match. This is typically easily done or automatically done with the supporting software accompanying a fingerprint verification device (3), or with modified or supplemental software supplied by the school through a disk or a download into the enrollee computer (1). This modified or supplemental software may, for example, utilize the security protocols of the operating system software, such as WINDOWS®, to affect the activation times for the fingerprint verification device to require a fingerprint verification. This modified or supplemental software may otherwise, for example, affect the manufacturer's supporting software for the fingerprint verification device (3), thereby allowing the desired fingerprint verification time or times, for the fingerprint verification device (3) to require fingerprint verification. The fingerprint resolution or the number of matching fingerprint identifiers used in the fingerprint verification device (3) is factory set or specified by the school, and may be verified by the school computer (4) over the enrollee-school communications link (7). Once the enrollee computer (1) is in communication with the school computer (4), with an enrollee-school communications link (7), the enrollee is instructed to register online, if they have not yet done so either online or off-line. A part of the online registration process would typically include scanning a fingerprint on the fingerprint verification device (3), where it is transmitted to the enrollee computer (1) by a fingerprint device communications link (9), and then it is transmitted from the enrollee computer (1) to the school computer (4), by an enrollee-school communications link (7) over the internet, or the like. Once the enrollee is registered with the school for an online course or program of study, the enrollee may log-in to begin the course. This may be done at a time specified by the school or at the enrollee's convenience, as the school so determines. The log-in process would typically involve at lease one fingerprint scan on the fingerprint verification device (3), to confirm that the identity of the attendee is the same as that of the enrollee, that had registered for the course. The fingerprint verification process may be accomplished on the enrollee computer (1) following the registration process and scan and incorporation of the enrollee's fingerprint into the supporting memory or a supporting memory component of the supporting software for the fingerprint verification device (3), or the fingerprint verification process may be accomplished on the school computer (4), where the enrollee's fingerprint may have been entered into their data bank. Once the log-in process is complete, the enrollee may proceed with the on-line course. The course may be comprised of instruction, lecture and demonstrations, or a combination thereof, and optionally with one or more periodic tests or the like.

In some simple embodiments of the Fingerprint Verification System, one or more additional fingerprint scans on the fingerprint verification device (3), for fingerprint authentication may be required at the time that the enrollee takes a test. Such a fingerprint scan may be set prior to beginning the test, following the completion of the test, or at some time during the test taking, or at a plurality of such times. The times for said fingerprint scans may be easily set within the software for the course content, on the school computer (4) or the school's web server (4), or the like, or within the aforementioned supporting or supplemental software for the fingerprint verification device (3) or course content.

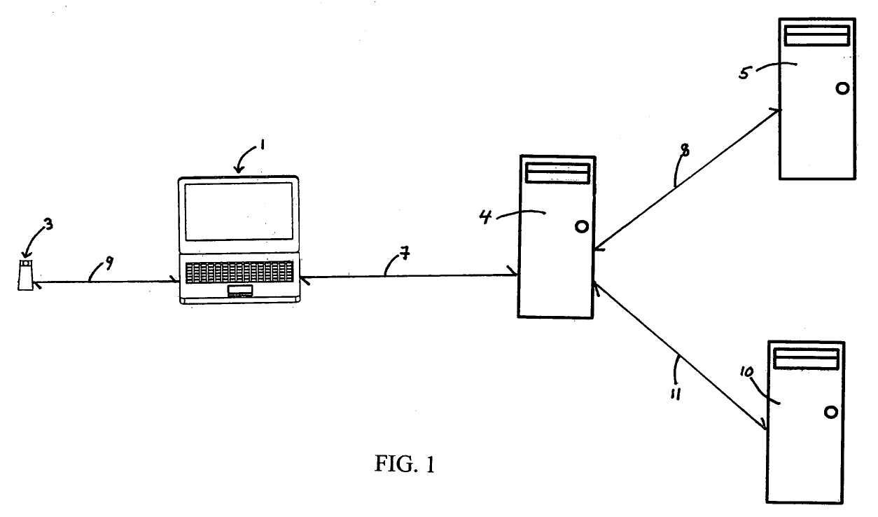

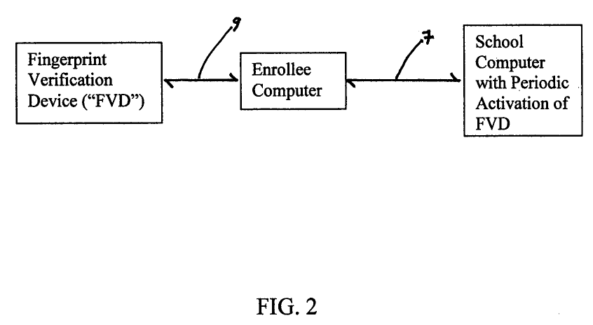

FIG. 1 shows a set-up for the online Fingerprint Verification System, and FIG. 2 shows a block diagram for a simple embodiment of the online System.

### Description of Online Embodiments with Periodic Fingerprint Authentication Times

Embodiments of the online Fingerprint Verification System with periodic fingerprint authentication times would be comprised essentially of an enrollee computer (1) connected to the internet, with a telephone line, cable communications, or the like, and having an enrollee-school communications link (7) with a school computer (4), and with data flowing along said link (7) and between both the enrollee computer (1) and the school computer (4). A fingerprint verification device (3) is connected to and in communications with the enrollee computer (1) with a fingerprint device communications link (9), and said device (3) is indirectly in communication with the school computer (4), by way of the enrollee computer (1) and with the enrollee-school communications link (7). The level of security for the fingerprint verification device (3) is typically factory set, and is set so that the enrollee is reliably identified when the fingerprint verification device (3) is activated and used. A higher level of security may be achieved by adjusting the resolution or the number of matching fingerprint identifiers, such as fingerprint loops and curves, and the like, required on the fingerprint verification device (3), to recognize a fingerprint match. This is typically easily done or automatically done with the supporting software accompanying a fingerprint verification device (3), or with modified or supplemental software supplied by the school through a disk or a download into the enrollee computer (1). This modified or supplemental software may, for example, utilize the security protocols of the operating system software, such as WINDOWS®, to affect the periodic activation times for the fingerprint verification device to require a fingerprint verification. This modified or supplemental software may otherwise, for example, affect the manufacturer's software for the fingerprint verification device (3), thereby allowing, if need be, periodic types of fingerprint verification times, for the fingerprint verification device (3) to require fingerprint verification. The fingerprint resolution or the number of matching fingerprint identifiers used in the fingerprint verification device (3) is factory set or specified by the school, and may be verified by the school computer (4) over the enrollee-school communications link (7). Once the enrollee computer (1) is in communication with the school computer (4), with an enrollee-school communications link (7), the enrollee is instructed to register online, if they have not yet done so either online or off-line. A part of the online registration process would typically include scanning a fingerprint on the fingerprint verification device (3), where it is transmitted to the enrollee computer (1) by a fingerprint device communications link (9), and then it is transmitted from the enrollee computer (1) to the school computer (4), by an enrollee-school communications link (7) over the internet, or the like. Once the enrollee is registered with the school for an online course or program of study, the enrollee may log-in to begin the course. This may be done at a time specified by the school or at the enrollee's convenience, as the school so determines. The log-in process would typically involve at lease one fingerprint scan on the fingerprint verification device (3), to confirm that the identity of the attendee is the same as that of the enrollee, that had registered for the course. The fingerprint verification process may be accomplished on the enrollee computer (1) following the registration process and scan and incorporation of the enrollee's fingerprint into the supporting memory or a supporting memory component of the supporting software for the fingerprint verification device (3), or the fingerprint verification process may be accomplished on the school computer (4), where the enrollee's fingerprint has been entered into their data bank. Once the log-in process is complete, the enrollee may proceed with the on-line course. The course may be comprised of instruction, lecture and demonstrations, or a combination thereof, and optionally with one or more periodic tests or the like.

In these embodiments of the Fingerprint Verification System and at periodic times throughout the course, a plurality of fingerprint scans are taken on the fingerprint verification device (3), and one or more fingerprint scans for fingerprint authentication may be required at the time that the enrollee takes a test. Such a fingerprint scan may be set prior to beginning the test, following the completion of the test, or at some time during the test taking, or at a plurality of such times. The times for said fingerprint scans are more easily set within the software for the course content, on the school computer (4) or the school's web server (4), or the like, or with the aforementioned supporting or supplemental software for the fingerprint verification device (3) or course content. The periodicity of the fingerprint scans may be based on a function of time, such as every ten minutes, or the periodicity may be based on the portion of the course being studied, such as at the beginning of each chapter or segment of the course, and at the beginning of each test for the course. Another form of periodicity might be based on both time and the portion of the course being studied, such as at the beginning of each segment of the course and test, and every fifteen minutes throughout the course and its one or more tests. These various embodiments of the Fingerprint Verification System with periodic fingerprint authentication times, assures a reasonable security and likelihood that the attendee is the enrollee, if the fingerprints match.

FIG. 1 shows a basic set-up for the online Fingerprint Verification System, and FIG. 2 shows a block diagram for an embodiment of the online System with periodic fingerprint authentication times.

### Description of Online Embodiments with Random Fingerprint

Embodiments of the online Fingerprint Verification System with random, pseudorandom, or seemingly random fingerprint authentication times would be comprised essentially of an enrollee computer (1) connected to the internet, with a telephone line, cable communications, or the like, and having an enrollee-school communications link (7) with a school computer (4), and with data flowing along said link (7) and between both the enrollee computer (1) and the school computer (4). A fingerprint verification device (3) is connected to and in communications with the enrollee computer (1) with a fingerprint device communications link (9), and said device (3) is indirectly in communication with the school computer (4), by way of the enrollee computer (1) and with the enrollee-school communications link (7). The level of security for the fingerprint verification device (3) is typically factory set, and is set so that the enrollee is reliably identified when the fingerprint verification device (3) is activated and used. A higher level of security may be achieved by adjusting the resolution or the number of matching fingerprint identifiers, such as fingerprint loops and curves, and the like, required on the fingerprint verification device (3), to recognize a fingerprint match. This is typically easily done or automatically done with the supporting software accompanying a fingerprint verification device (3), or with modified or supplemental software supplied by the school through a disk or a download into the enrollee computer (1). This modified or supplemental software may, for example, utilize the security protocols of the operating system, such as WINDOWS®, to affect the random activation times for the fingerprint verification device to require a fingerprint verification. This modified or supplemental software may otherwise, for example, affect the manufacturer's supporting software for the fingerprint verification device (3), thereby allowing the random types of fingerprint verification times, for the fingerprint verification device (3) to require fingerprint verification. The fingerprint resolution or the number of matching fingerprint identifiers used in the fingerprint verification device (3) is factory set or specified by the school, and may be verified by the school computer (4) over the enrollee-school communications link (7). Once the enrollee computer (1) is in communication with the school computer (4), with an enrollee-school communications link (7), the enrollee is typically instructed to register online, if they have not yet done so either online or off-line. A part of the online registration process may include scanning a fingerprint on the fingerprint verification device (3), where it is transmitted to the enrollee computer (1) by a fingerprint device communications link (9), and then it is transmitted from the enrollee computer (1) to the school computer (4), by an enrollee-school communications link (7) over the internet, or the like. Once the enrollee is registered with the school for an online course or program of study, the enrollee may log-in to begin the course. This may be done at a time specified by the school or at the enrollee's convenience, as the school so determines. The log-in process would typically involve at lease one fingerprint scan on the fingerprint verification device (3), to confirm that the identity of the attendee is the same as that of the enrollee, that had registered for the course. The fingerprint verification process may be accomplished on the enrollee computer (1) following the registration process and scan and incorporation of the enrollee's fingerprint into the supporting memory or a supporting memory component of the supporting software for the fingerprint verification device (3), or the fingerprint verification process may be accomplished on the school computer (4), where the enrollee's fingerprint has been entered into their data bank. Once the log-in process is complete, the enrollee may proceed with the on-line course. The course may be comprised of instruction, lecture and demonstrations, or a combination thereof, and optionally with one or more periodic tests or the like.

In these embodiments of the Fingerprint Verification System and at a plurality of seemingly random times throughout the course, fingerprint scans are taken on the fingerprint verification device (3), and a fingerprint scan for fingerprint authentication may be required at the time that the enrollee takes a test. Such a fingerprint scan may be set prior at a random time during the test, or at a plurality of random times during the test. The times for said fingerprint scans are more easily set within the software for the course content, on the school computer (4) or their web server (4), or the like, or within the aforementioned supporting or supplemental software for the fingerprint verification device (3) or course content. The software-based randomicity or pseudorandomicity of the fingerprint scans may be randomly based on a function of time throughout the length of the course. One or more additional fingerprint scans for fingerprint verification may be required at the time that the enrollee takes each test, at a random, pseudorandom, or seemingly random times between the very beginning and the very end of the test. There are a number of random number generators, algorithms, or number theoretic means of generating pseudorandom sequences, and the like, that may be used to generate the times when a fingerprint scan is required of the attendee. These various embodiments of the Fingerprint Verification System with random, pseudorandom, or seemingly random fingerprint authentication times, assures a reasonable security and likelihood that the attendee and test taker is the enrollee, if the fingerprints match.

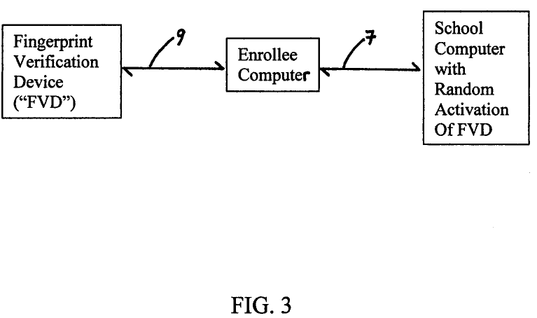

FIG. 1 shows a basic set-up for the online Fingerprint Verification System, and FIG. 3 shows a block diagram for an embodiment of the online System with random fingerprint authentication times.

### Description of Online Embodiments with Periodic and Random Fingerprint Authentication Times

Embodiments of the online Fingerprint Verification System with periodic and random or pseudorandom fingerprint authentication times would be comprised essentially of an enrollee computer (1) connected to the internet, with a telephone line, cable communications, or the like, and having an enrollee-school communications link (7) with a school computer (4), and with data flowing along said link (7) and between both the enrollee computer (1) and the school computer (4). A fingerprint verification device (3) is connected to and in communications with the enrollee computer (1) with a fingerprint device communications link (9), and said device (3) is indirectly in communication with the school computer (4), by way of the enrollee computer (1) and with the enrollee-school communications link (7). The level of security for the fingerprint verification device (3) is typically factory set, and is set so that the enrollee is reliably identified when the fingerprint verification device (3) is activated and used. A higher level of security may be achieved by adjusting the resolution or the number of matching fingerprint identifiers, such as fingerprint loops and curves, and the like, required on the fingerprint verification device (3), to recognize a fingerprint match. This is typically easily done or automatically done with the supporting software accompanying a fingerprint verification device (3), or with modified or supplemental software supplied by the school through a disk or a download into the enrollee computer (1). This modified or supplemental software may, for example, utilize the security protocols of the operating system software, such as WINDOWS®, to affect the activation times, periodic, random, or both, for the fingerprint verification device to require a fingerprint verification. This modified or supplemental software may otherwise, for example, affect the manufacturer's supporting software for the fingerprint verification device (3), thereby allowing, if need be, periodic, random, or both types of fingerprint verification times, for the fingerprint verification device (3) to require fingerprint verification. The fingerprint resolution or the number of matching fingerprint identifiers used in the fingerprint verification device (3) is factory set or specified by the school, and may be verified by the school computer (4) over the enrollee-school communications link (7). Once the enrollee computer (1) is in communication with the school computer (4), with an enrollee-school communications link (7), the enrollee is typically instructed to register online, if they have not yet done so either online or off-line. A part of the online registration process would include scanning a fingerprint on the fingerprint verification device (3), where it is transmitted to the enrollee computer (1) by a fingerprint device communications link (9), and then it is transmitted from the enrollee computer (1) to the school computer (4), by an enrollee-school communications link (7) over the internet, or the like. Once the enrollee is registered with the school for an online course or program of study, the enrollee may log-in to begin the course. This may be done at a time specified by the school or at the enrollee's convenience, as the school so determines. The log-in process would typically involve at lease one fingerprint scan on the fingerprint verification device (3), to confirm that the identity of the attendee is the same as that of the enrollee, that had registered for the course. The fingerprint verification process may be accomplished on the enrollee computer (1) following the registration process and scan and incorporation of the enrollee's fingerprint into the supporting memory or a supporting memory component of the supporting software for the fingerprint verification device (3), or the fingerprint verification process may be accomplished on the school computer (4), where the enrollee's fingerprint has been entered into their data bank. Once the log-in process is complete, the enrollee may proceed with the on-line course. The course may be comprised of instruction, lecture and demonstrations, or a combination thereof, and optionally with one or more periodic tests or the like.

In these embodiments of the Fingerprint Verification System and at a plurality of periodic and at seemingly random times throughout the course, fingerprint scans are taken on the fingerprint verification device (3), and one or more fingerprint scans for fingerprint authentication may be required at the time that the enrollee takes a test, and such fingerprint scans are optimally taken at periodic and seemingly random times during the test taking.

The periodicity aspect of the fingerprint authentication times may be based on a function of time, such as every ten minutes, or the periodicity may be based on the portion of the course being studied, such as at the beginning of each chapter or segment of the course, and at the beginning of each test for the course. Another form of periodicity might be based on both time and the portion of the course being studied, such as at the beginning of each segment of the course and test, and every fifteen minutes throughout the course and its one or more tests. These times may be set within the aforementioned supporting or supplemental software for the fingerprint verification device (3) or course content.

The randomicity or pseudorandomicity aspect of the fingerprint authentication times may are more easily set within the software for the course content, on the school computer (4) or their web servers (4), or the like, or within the aforementioned supporting or supplemental software for the fingerprint verification device (3) or course content, and may be randomly or pseudorandomly based on a function of time throughout the length of the course. One or more additional fingerprint scans for fingerprint verification may be required at the time that the enrollee takes each test, at random, pseudorandom, or seemingly random times between the very beginning and the very end of the test. There are a number of random number generators, algorithms, or number theoretic means of generating pseudorandom sequences, and the like, that may be used to generate the times when a fingerprint scan is required of the attendee.

These various embodiments of the Fingerprint Verification System with both periodic and random, pseudorandom, or seemingly random authentication times, assures a reasonable security and likelihood that the attendee is the enrollee, if the fingerprints match.

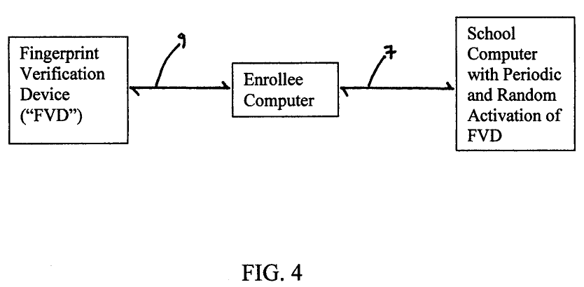

FIG. 1 shows a basic set-up for the online Fingerprint Verification System, and FIG. 4 shows a block diagram for an embodiment of the online System with both periodic and random fingerprint authentication times.

### Additional Embodiments of the Invention

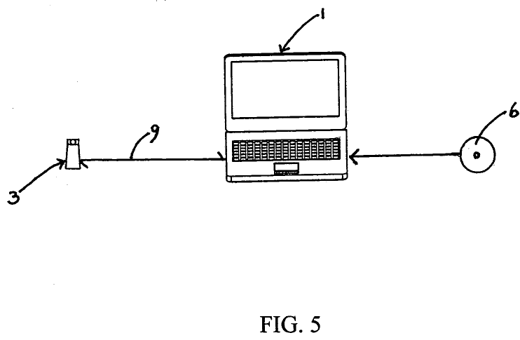

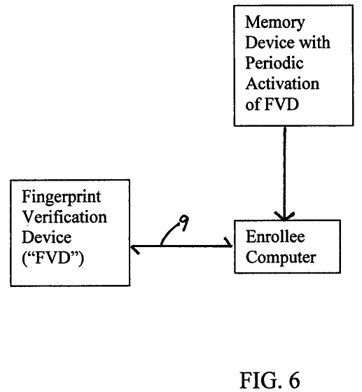

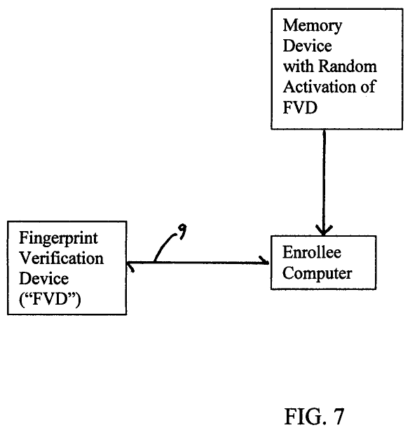

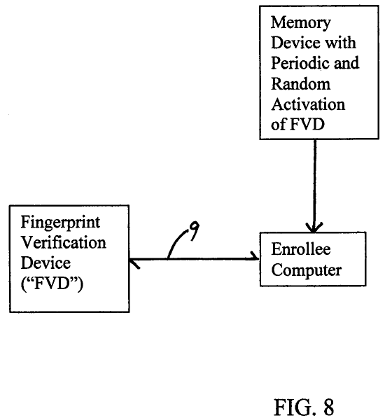

Other embodiments of the Fingerprint Verification System may also include the use of downloaded supporting or supplemental software and course content onto a hard drive (6), software and course content on CD (6), software and course content on DVD (6), software or course content on a memory stick (6), jump drive (6), or the like, or software and course content on another memory chip (6), memory card (6), memory device (6) or the like, so that the enrollee and their enrollee computer (1) with their fingerprint verification device (3), may effectively by-pass the internet connection with the school computer during all or most of the course, and may take the course remotely and disjoint from the internet or a computer network. The content of the course and its one or more tests may remain the same under these embodiments that are largely off-line, and the method and times of the attendee's fingerprint verification would take place, as disclosed in above online embodiments, and at periodic, seemingly random, or both periodic and seemingly random times throughout the off-line course and its associated tests. Block diagrams further disclosing and illustrating these off-line embodiments of the Fingerprint Verification System are in shown in FIGS. 5 through 8, inclusive, and are for the plan view of the off-line Fingerprint Verification System shown in FIG. 5, the periodic verification embodiments shown as a block diagram in FIG. 6, the seemingly random verification embodiments shown as a block diagram in FIG. 7, and the periodic and seemingly random verification embodiments shown as a block diagram in FIG. 8.

Other embodiments of the Fingerprint Verification System may also include kits for the embodiments as disclosed above and as shown in FIGS. 1-9, including fingerprint identification devices (3) with supporting or supplemental software and course content in the form of a memory device (6) or disk (6), if the embodiment is off-line, that may be utilized by independent schools, franchises, associate institutions, on computer networks, and the like.

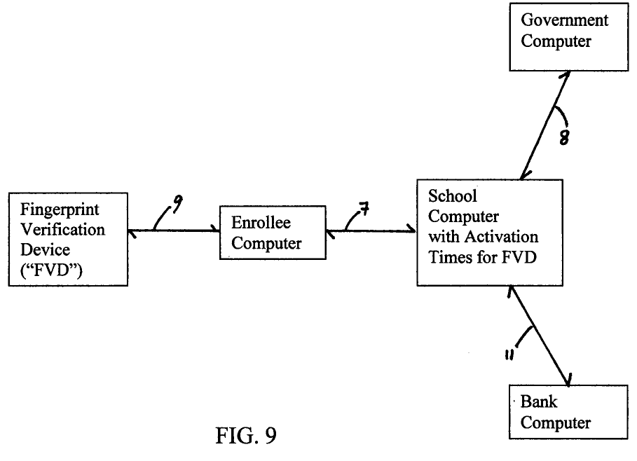

Other embodiments of the online Fingerprint Verification System may additionally include means of taking secured credit card payments, at one or more times during the course enrollment or during the progress of the course. Such payments during the progress of the course may be made at the beginning of the course, the end of the course, periodically throughout the course, such as for each segment or chapter of the course, or prior to beginning the course. The various embodiments of the Fingerprint Verification System may optionally have a means of taking secured credit card payments, as shown in FIG. 9, where the shown optional school-bank communications link (11) between the school computer and the shown optional bank computer (10) is utilized, rather than not necessarily being a part of the System, as with the previously disclosed embodiments.

Other embodiments of the Fingerprint Verification System may use one or more government communications links (8) to transmit fingerprint information, or attendance and test information, or a combination thereof, to a government computer (5), to authenticate the identity of the attendee and examinee, and to make a government record of the course and its transactions. Said Fingerprint Verification System with an optional government communications link (8) is shown in a block diagram in FIG. 9. Said government communications link (8) may be between the enrollee computer (1) or the school computer (4), and the government computer (5), but the optimal embodiment would be between the school computer (4) and the government computer (5), as shown in FIG. 9.

Other embodiments of the invention may include the methods disclosed throughout this specification and FIGS. 1-9, and as itemized below, to use a fingerprint identification device (3) to verify and authenticate the identity of the person attending an online course or program, and taking a quiz, test, examination, or writing an essay, or the like. Such a method for a Fingerprint Verification System may be comprised essentially of the following steps:

a. Connect a fingerprint verification device (3) to an enrollee computer (1), with a fingerprint device-enrollee computer communications link (9).

b. Load or download supporting software (6), and desired supplemental software (6) for the fingerprint verification device (3).

c. Log onto a school computer (4), through an enrollee-school communications link (7) and, if need be, register for the course through said link (7) and, if need be, pay for the course, through a direct enrollee-bank communications link or indirect communications links (7 and 11, respectively), that is a enrollee-school communications link (7) and a school-bank communications link (11), to a bank computer (10).

d. Then begin the online course, with occasional required fingerprint verification, using a fingerprint scan on the fingerprint verification device (3).

e. Conclude the online course with optional testing and fingerprint verification, and by logging off-line.

Other embodiments of the invention may include the methods disclosed throughout this specification and FIGS. 1-9, and as itemized below, to use a fingerprint identification device (3) to verify and authenticate the identity of the person attending an off-line course or program, and taking a quiz, test, examination, or writing an essay, or the like. Such a method for a Fingerprint Verification System may be comprised essentially of the following steps:

a. Connect a fingerprint verification device (3) to the enrollee computer (1) with a fingerprint device-enrollee computer communications link (9).

b. Load supporting software (6) and desired supplemental software (6) for the fingerprint verification device (3), into the enrollee computer (1).

c. Load course content (6) into the enrollee computer (1).

d. Begin the course with occasional required fingerprint verification required using a fingerprint scan on the fingerprint verification device (3), and data logged to a memory device (6).

e. Conclude course with optional testing and fingerprint verification, and data logged to a memory device (6).

While I have shown and described in this disclosure and its appended drawing figures, and which are a part of and incorporated in said disclosure, only selected embodiments in accordance with the present invention, it is understood that the same is not limited thereto, but is susceptible to numerous changes and modifications as know to one having ordinary skill in the art, and I therefore do not wish to be limited to the details shown and described herein, but intended to cover all such modifications, changes, eliminations, combinations, and hybrids, as are encompassed by the scope of the appended claims.

I claim:

1. A Fingerprint Verification System comprised essentially of:
a. a fingerprint verification device in communication with an enrollee computer through a fingerprint device-enrollee computer communications link;
b. said enrollee computer in communication with a school computer through an enrollee-school communications link;
c. said school computer provides enrollee computer with a course of study through said enrollee-school communications link;
d. during said course of study, an enrollee for the course of study is required to scan a finger on said fingerprint verification device, for attendance verification, in said course of study.

2. A Fingerprint Verification System comprised essentially of said System as recited in claim 1, and further comprised essentially of the fingerprint verification device to be activated at a set time to require a fingerprint scan.

3. A Fingerprint Verification System comprised essentially of said System as recited in claim 1, and further comprised essentially of the fingerprint verification device to be activated randomly to require a fingerprint scan.

4. A Fingerprint Verification System comprised essentially of said System as recited in claim 1, and further comprised essentially of the fingerprint verification device to be activated periodically and a plurality of times to require fingerprint verification.

5. A Fingerprint Verification System comprised essentially of said System as recited in claim 1, and further comprised essentially of the fingerprint verification device to be activated randomly and a plurality of times to require fingerprint verification.

6. A Fingerprint Verification System comprised essentially of said System as recited in claim 1, and further comprised essentially of the fingerprint verification device to be activated both periodically and randomly, and a plurality of times to require fingerprint verification.

7. A Fingerprint Verification System comprised essentially of said System as recited in claim 1, and further comprised essentially of the school computer in communication with a government computer through a government communications link.

8. A Fingerprint Verification System comprised essentially of said System as recited in claim 1, and further comprised essentially of the school computer in communication with a bank computer through a school-bank communications link.

9. A Fingerprint Verification System comprised essentially of said System as recited in claim 1, and further comprised essentially of the course of study being a traffic school course of study.

10. A Fingerprint Verification System comprised essentially of said System as recited in claim 1, and further comprised essentially of the course of study as allowed by a Court of Law.

11. A Fingerprint Verification System comprised essentially of said System as recited in claim 7, and further comprised essentially of the course of study as allowed by a Court of Law.

12. A Fingerprint Verification System comprised essentially of said System as recited in claim 1, and further comprised essentially of the course of study as allowed by a licensing agency.

13. A Fingerprint Verification System comprised essentially of:
a. a fingerprint verification device in communication with an enrollee computer through a fingerprint device-enrollee computer communications link;
b. a memory device with a course of study from a school, said memory device to be loaded into said enrollee computer prior to beginning said course of study;
c. said memory device processes supporting software for activation times for said fingerprint verification device to require fingerprint verification of the enrollee;
d. during the course of study, an enrollee for the course of study is required to scan a finger on the fingerprint verification device, for attendance verification, in said course of study;
e. an attendance verification log of fingerprint scan results is entered onto the memory device for later transfer to said school.

14. A Fingerprint Verification System comprised essentially of the System recited in claim 13, and further comprised essentially of said fingerprint verification device to be activated at a set time to require a fingerprint scan.

15. A Fingerprint Verification System comprised essentially of the System recited in claim 13, and further comprised essentially of said fingerprint verification device to be activated randomly to require a fingerprint scan.

16. A Fingerprint Verification System comprised essentially of the System recited in claim 13, and further comprised essentially of said fingerprint verification device to be activated periodically and a plurality of times to require fingerprint verification.

17. A Fingerprint Verification System comprised essentially of the System recited in claim 13, and further comprised essentially of said fingerprint verification device to be activated randomly and at a plurality of times to require fingerprint verification.

18. A Fingerprint Verification System comprised essentially of the System recited in claim 13, and further comprised essentially of the course of study being a traffic school course of study.

19. A Method for a Fingerprint Verification System, comprised essentially of:
a. connecting a fingerprint verification device to an enrollee computer with a fingerprint device-enrollee computer communications link;
b. load a supporting software for said fingerprint verification device, onto said enrollee computer;
c. log onto a school computer, through an enrollee-school communications link;
d. begin a course of study from said school computer, with occasional required fingerprint verification, using a fingerprint scan on the fingerprint verification device;
e. conclude said course of study by logging off-line.

20. A Method for a Fingerprint Verification System, as recited in claim 19, and further comprised essentially of the course of study being a traffic school course of study.
